(19) United States
(12) Patent Application Publication
(10) Pub. No.: US 2004/0032452 A1
(43) Pub. Date: Feb. 19, 2004

(54) Nozzle array for achieving nozzle redundancy in a printer

(76) Inventor: Josep-Maria Serra, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/222,653

(22) Filed: Aug. 15, 2002

(51) Int. Cl. B41J 2/145

(52) U.S. Cl. 347/40

(57) ABSTRACT

A printer having a cartridge with an array of nozzles for disposing ink onto a print medium. The array of nozzles are tilted at an angle relative to that of the print medium. By tilting the nozzles relative to the print medium, the nozzle from one column can reside on the same line as the nozzle from a different column. Thereby, nozzle redundancy is achieved.

### TECHNICAL FIELD

The present invention pertains to a printer having a nozzle array which is tilted relative to the print medium in order to achieve nozzle redundancy.

### BACKGROUND ART

Inkjet printing mechanisms are used in a variety of different products, such as plotters, facsimile machines and printers, collectively referred to herein as inkjet printers. These inkjet printers contain inkjet cartridges, often called “pens.” A pen includes a reservoir of ink and a print head. The function of the print head is to eject minute ink drops, disposed from the ink reservoir, onto a blank sheet of paper. To print an image, the pen is mounted to a carriage in the printer. The carriage traverses over the surface of a blank sheet of paper, and the print head is controlled to eject drops of ink at appropriate times pursuant to commands from a microcomputer or other controller. The timing of the application of the ink drops corresponds to the pattern of the desired image or text to be printed.

The print head ejects the ink drops through several small nozzles.

The particular ink ejection mechanism within the print head may take on a variety of different forms known to those skilled in the art, such thermal print head technology. In a thermal system, a barrier layer containing ink channels and vaporization chambers is located between a nozzle orifice plate and a substrate layer. This substrate layer typically contains linear arrays of heater elements, such as resistors, which are energized to heat ink within the vaporization chambers. Upon heating, an ink droplet is ejected from a nozzle associated with the energized resistor.

One common prior art nozzle array design entails using columns of nozzles arranged in a staggered configuration, as shown in FIG. 1. Print head 101 includes a left column of nozzles 103 and a right column of nozzles 104. The right column of nozzles 102 are staggered a short distance in the vertical direction relative to the left column of nozzles 103. This staggered configuration is advantageous because the nozzles can be placed in closer vertical proximity. Thereby, as each nozzle ejects its ink, the ink droplets can be placed closer together. This provides more dots per inch (dpi), which in turn, directly translates into higher resolution and improved picture quality.

FIG. 2 shows another commonly used prior art nozzle array configuration. The nozzles of print head 202 are arranged in two columns 203 and 204. The left column of nozzles 203 is adjacent to and parallel with the right column of nozzles 204. Each nozzle in the left column resides on the same x-axis as a nozzle in the right column relative to the print head 202. The print head 202 is then tilted relative to the print medium 201. In other words, the print medium 201 has a different X-axis and different Y-axis than the X-axis and Y-axis of print head 202. Instead of having the same X and Y axes, the X-axis of print head 202 is tilted at an angle (α) relative to the X-axis of the print medium. By tilting the print head 202 relative to the print medium 201, greater resolution is attained as opposed to not tilting the print head 202. If the print head 202 were not tilted, the vertical spacing between each of the nozzles would be X₂. However, tilting the nozzle array generates vertical spacing of X₁. It can be seen that the vertical spacing of X₁ is much smaller than that of X₂. Consequently, tilting this type of nozzle array configuration results in a higher dpi and improved print quality.

Unfortunately, having multiple, different nozzle array configurations leads to increased manufacturing costs, greater inventory overhead, and confusion to the end consumer as to which replacement cartridge they should ultimately purchase when their inkjet printer runs out of ink. Thus, prior art inkjet printers which are locked into one or another nozzle array configuration, suffer the limitations inherent to that chosen configuration. Furthermore, inkjet printer manufacturers face problems in producing, selling, and maintaining a host of various types of inkjet cartridges to support the different inkjet printer models sold.

### SUMMARY OF THE INVENTION

A printer having an array of nozzles which are tilted relative to the print medium is disclosed. The printer includes a cartridge which has an array of nozzles. The nozzles are used to eject drops of ink onto the print medium. By tilting the array of nozzles relative to the print medium, nozzle redundancy is achieved.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a prior art nozzle array of an inkjet printer having two columns of nozzles, parallel to one another, in a staggered configuration.

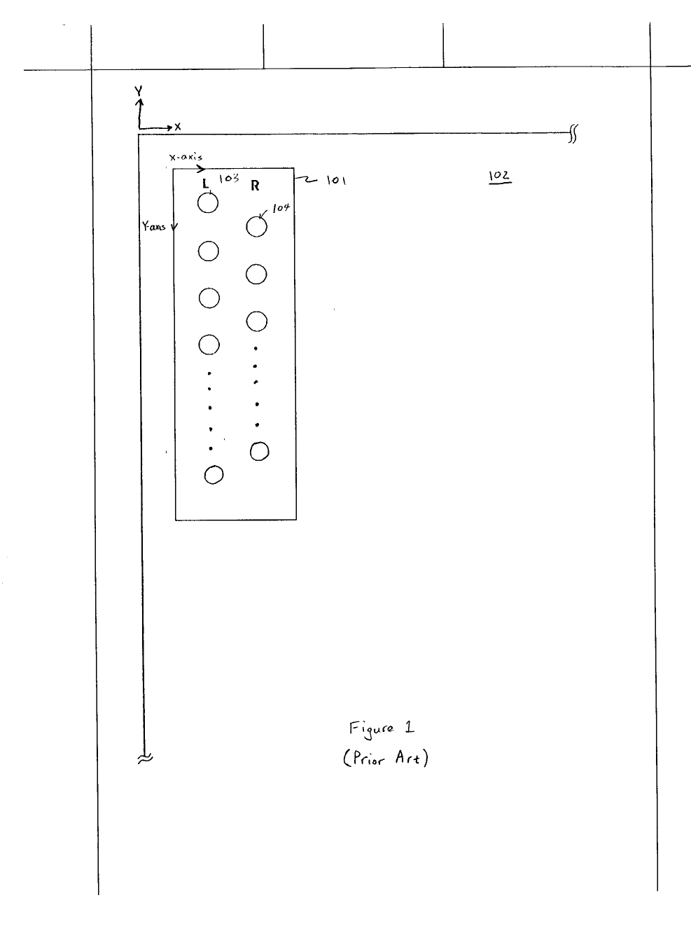

FIG. 2 shows another commonly used prior art nozzle array configuration.

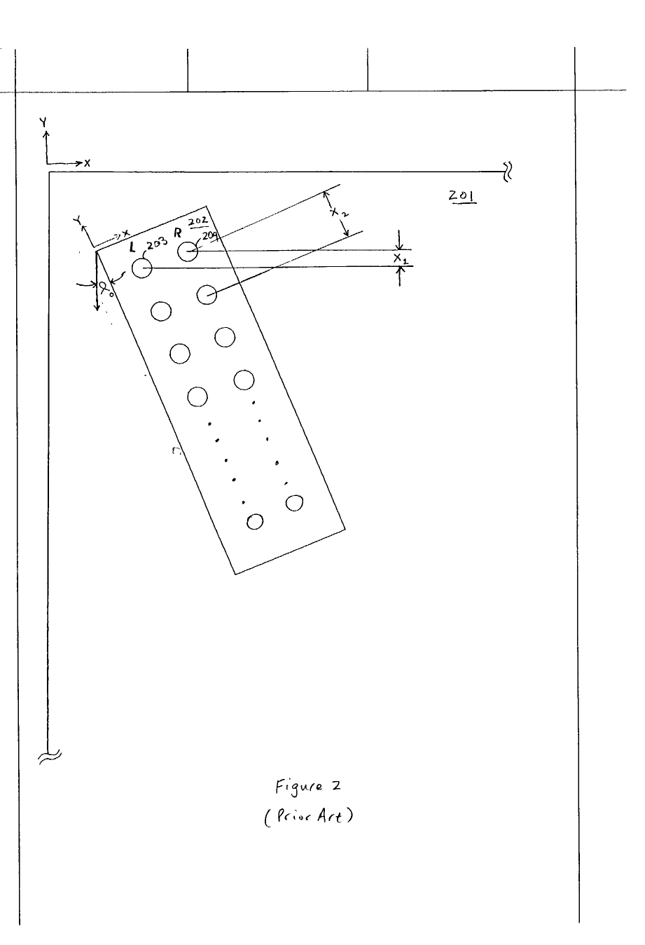

FIG. 3 shows one embodiment of the present invention of an inkjet print head having a staggered nozzle array which is tilted relative to the print medium.

FIG. 4 shows an inkjet printer having two separate cartridges.

FIG. 5 shows an actuator which is used to physically rotate a cartridge such that it can be tilted relative to the print medium.

FIG. 6 shows yet another embodiment of the present invention, whereby a print head containing three or more columns of nozzles, is tilted for nozzle redundancy.

FIG. 7 shows one embodiment of the present invention where the nozzle array is tilted such that nozzle redundancy is provided between offset nozzles.

### DETAILED DESCRIPTION OF THE INVENTION

The present invention relates to an inkjet print head having a nozzle array which is tilted relative to the print medium in order to achieve nozzle redundancy. The nozzles are tilted to such a degree as to Tilting the nozzle array relative to the print medium enables the same inkjet pen to be compatible for usage in many different inkjet printer models. Furthermore, greater flexibility is attained by virtue of having the option of selectively either tilting or not tilting the nozzle array. Depending on the user's dictates, the nozzle array can be tilted to improve speed and reliability; not tilted for better print quality; or vice versa. Rather than having two separate types of nozzle array configurations, the present invention enables the same nozzle array configuration to be used in two different modes, simply by virtue of tilting or not tilting that nozzle array configuration. In the following detailed description of the present invention, numerous specific details are set forth in order to provide a thorough understanding of the present invention. However, the present invention may be practiced without these specific details or by using alternate elements or methods. In other instances well known methods, procedures, components, and circuits have not been described in detail as not to unnecessarily obscure aspects of the present invention.

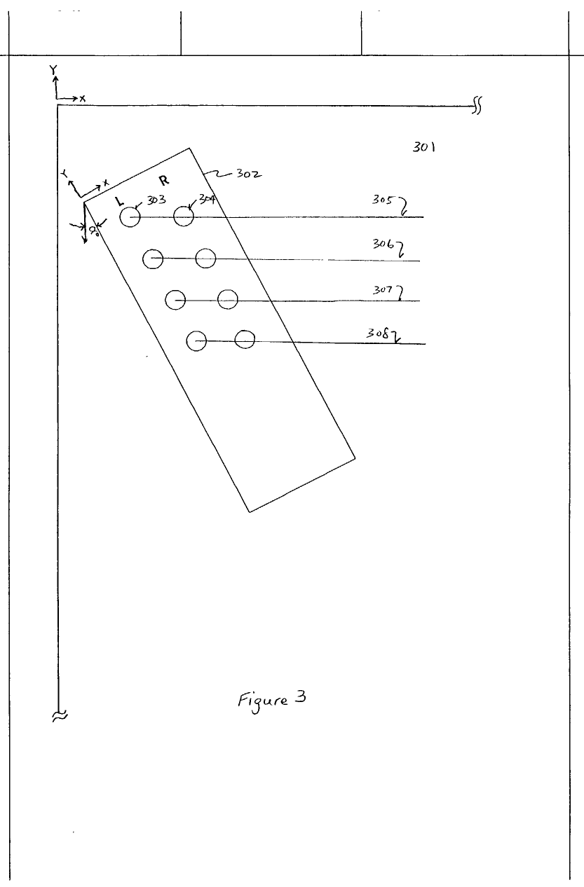

FIG. 3 shows one embodiment of the present invention of an inkjet print head having a staggered nozzle array which is tilted relative to the print medium. An inkjet print head 302 contains two columns of nozzles. The left column of nozzles 303 is adjacent to and parallel with the right column of nozzles 304. Each nozzle in the left column is vertically staggered with respect to a nozzle in the right column relative to the print head 302. The print head 302 is tilted relative to the print medium 301. Instead of having the same X and Y axes, the X-axis of print head 302 is tilted at an angle (α) relative to the X-axis of the print medium 301. In other words, the print medium 301 has a different X-axis and different Y-axis than the X-axis and Y-axis of print head 302. The goal of this particular embodiment is to tilt print head 302 such that the columns of nozzles, of this otherwise staggered nozzle array configuration, align vertically relative to the print medium 301. In one embodiment, the degree of tilt is approximately two degrees. The reason for this relatively small degree of tilt is because the nozzles are extremely small and are closely spaced together. As a result, a small degree of tilt can produce a rather substantial degree of vertical separation.

By tilting the print head 302 relative to the print medium 301, the nozzles of the left column can be vertically aligned with the nozzles of the right column. In other words, each nozzle in the left column 303 has a corresponding nozzle in the right column 304 which also corresponds to that same X-axis of the print medium. It can be seen that each of the rows 305-307 has a corresponding set of two nozzles for ejecting ink onto those respective rows. This dual nozzle redundancy design is advantageous because if one nozzle were to misfire, clog, or otherwise malfunction, the other nozzle would be available to fire in its place because it is located in the same horizontal position. For example, if one of the nozzles in the right column were to malfunction, the corresponding nozzle in the left column would be able to fire on that same line. Although this leads to a slight degradation of the image quality, it nonetheless, is much better than having no nozzles available. For instance, rather than missing data for an entire line, the line with the defective nozzle would appear slightly lighter in color. The resultant printout might be acceptable to the end user. Otherwise, a malfunctioning nozzle might result in unacceptable print quality. The end user would be forced under those circumstances to replace a relatively expensive cartridge.

Besides offering greater reliability, this design also engenders faster printing because the firing frequency of the system is essentially doubled by virtue of having two columns of arrays which can be independently fired. Consequently, tilting this type of nozzle array configuration results in faster and more reliable printing. In another embodiment, having two nozzles on the same axis enables the inkjet printer to fire both nozzles simultaneously in order to increase the spot size. Increasing the spot size is of great significance because a bigger spot appears to be much darker in color. There may be instances where darker colors produces greater contrasts, which leads to sharper, enhanced print quality.

Furthermore, print head 302 can be installed in a conventional non-tilted mode into one inkjet printer model for producing a staggered nozzle output (e.g., for improved resolution). Alternatively, the same print head 302 can be installed in a tilted mode for nozzle redundancy in a different inkjet printer model (e.g., for faster and more reliable printing). This enables the same inkjet cartridge to be used and be compatible with two different inkjet model types. Those inkjet printer models which feature reliability and speed can now use the same inkjet cartridge as the inkjet printer models which feature improved resolution. Thereby, manufacturers can save production and inventory costs by reducing the number of different types of cartridges for supporting the various inkjet printer models. And reducing the different types of cartridges leads to less consumer confusion.

Similarly, a given print head can be installed in one inkjet printer model in a non-tilted mode to achieve one set of performance criteria (e.g., for improved resolution). Meanwhile, the same print head can be installed in the same inkjet printer model in a tilted mode to achieve a different set of performance criteria (e.g., for faster and more reliable printing). This confers greater flexibility and versatility to that particular inkjet printer model. It effectively enhances the overall functionality of that inkjet printer. Thereby, that inkjet printer can be sold at a higher premium and offers a competitive advantage over other similar inkjet printers on the market.

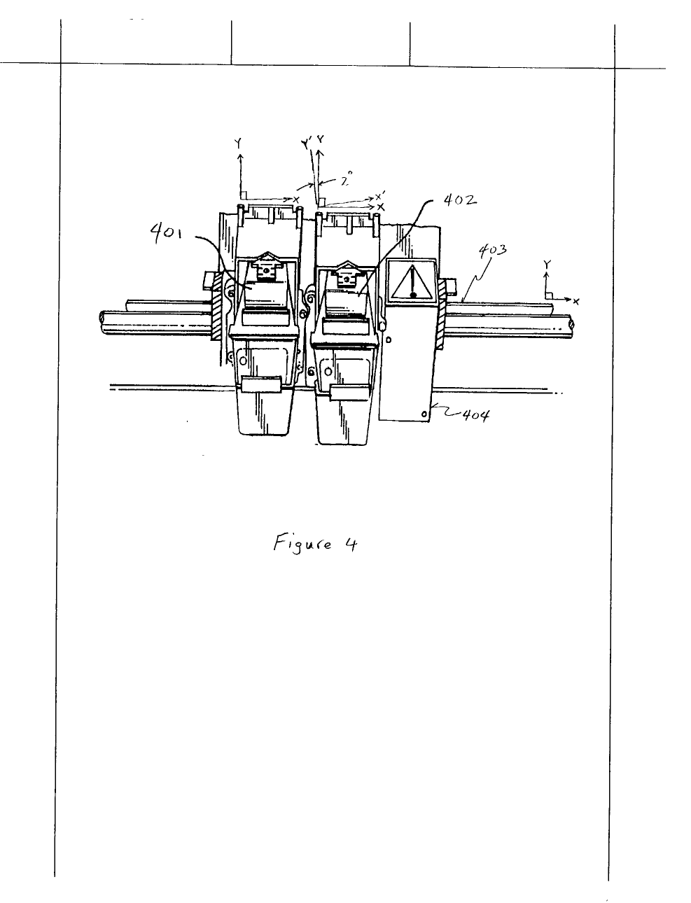

In one embodiment, two separate cartridges are incorporated into a single inkjet printer. FIG. 4 shows an inkjet printer having two separate cartridges 401 and 402. Both cartridges 401 and 402 reside on carriage 403. The cartridges 401 and 402 are scanned across the print medium while laying down a swath of ink. Cartridges 401 and 402 can have the same nozzle array configuration. However, one of the cartridges is maintained in a conventional non-tilted mode, while the other cartridge is maintained in a tilted mode. For example, cartridge 401 can be aligned with the paper (i.e., cartridge 401 has the same X and Y axes as that of the blank sheet of paper). In contrast, cartridge 402 can be tilted relative to the paper (i.e., cartridge 402 has X′ and Y′ axes which are offset from the paper's X and Y axes).

As depicted in FIG. 4, cartridge 402 is tilted by two degrees. By implementing both tilted and non-tilted modes of operation, one can selectively choose between printing for higher resolution or printing for speed and reliability. Assuming that both cartridges 401 and 402 have a staggered nozzle array configuration, the non-tilted cartridge 401 is used for printing images at greater resolution, whereas the tilted cartridge 402 is used for faster, more reliable printing. The switching between the two cartridges can be selected by the inkjet's micro-controller or an embedded processor.

Furthermore, in one embodiment, a drop detector 504 provides feedback for automatically switching to a functioning nozzle in case of failure(s). Without a drop detector, in case of a malfunctioning nozzle, the line would still be printed, but with only half of the ink being deposited for that particular line. Although that line would appear lighter in color, having this nozzle redundancy feature is superior to having line being printed due to a single nozzle failure. However, with a drop detector 504, a malfunctioning nozzle can be detected and identified. Based on the feedback from examining the ink being deposited, the drop detector 504 knows which nozzle (if any) is defective. The redundant nozzle belonging to the same line as that of the malfunctioning nozzle, can now be programmed to eject the ink that had been designated for the malfunctioning nozzle. Consequently, the print quality would not suffer due to a nozzle failure. In any case, with or without a drop detector, the tilted redundant nozzle array configuration of the present invention provides superior results in case of one or more nozzle failures.

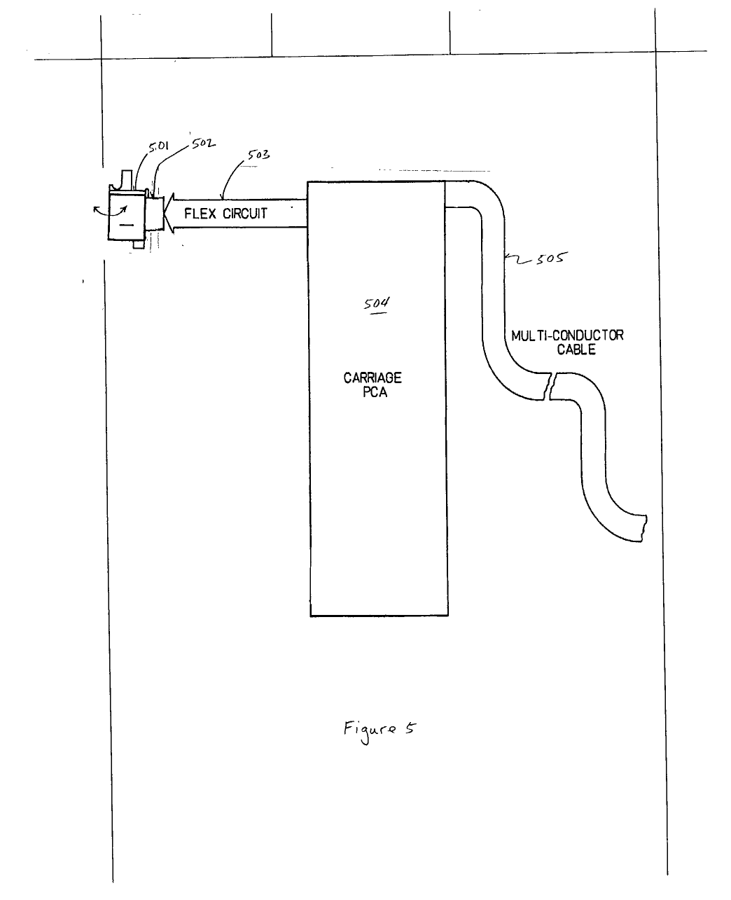

In another embodiment, a cartridge can be physically rotated such that it traverses across the print medium in a tilted mode. FIG. 5 shows an actuator 502 which is used to physically rotate cartridge 501 such that it can be tilted relative to the print medium. Cartridge 501, containing an array of staggered nozzles, is mechanically coupled to an actuator 502. Actuator 502 can be a simple motor, whose function is to rotate cartridge 501. In its default mode, cartridge 501 is maintained in a conventional, non-tilted mode. A controller residing within the inkjet printer can send a command via the multi-conductor cable 505 to the carriage printed circuit assembly 604, and flex circuit 503 to cause actuator 502 to rotate cartridge 501. Rotating cartridge 501 can cause the nozzle array to simulate the function of nozzle redundancy. Thereby, physically rotating cartridge can effectively cause the same printer, using the same cartridge, to print for either higher resolution or for faster speed and reliability.

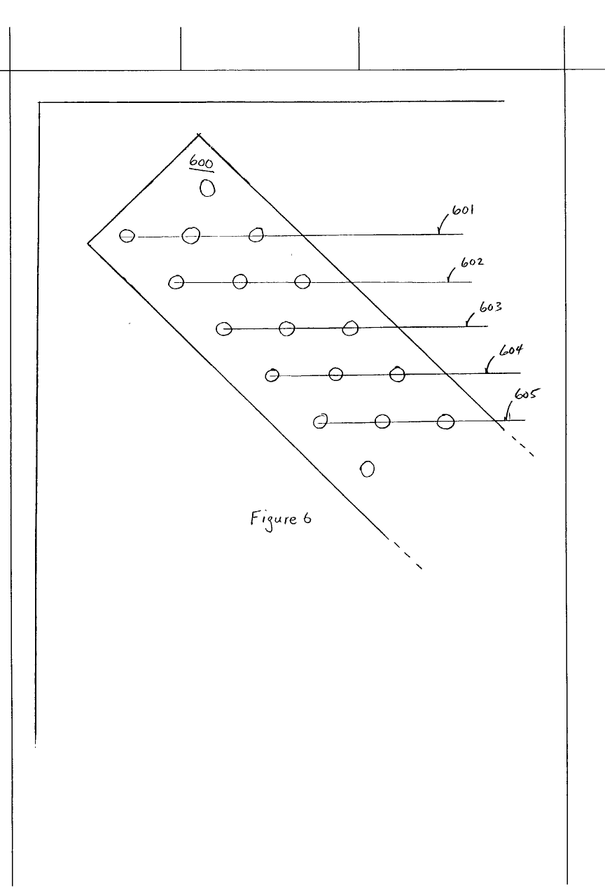

FIG. 6 shows yet another embodiment of the present invention, whereby a print head 600 containing three or more columns of nozzles, is tilted for nozzle redundancy. In this embodiment, the print head 601 contains three columns of nozzles. Print head 601 is tilted relative to the print medium such that all three columns of nozzles are arranged for horizontal alignment relative to the print medium. It can be seen that row 601 has nozzles 606, 607, and 608 which can eject ink onto that particular row. Likewise, rows 602-605 have three independent nozzles which can eject ink onto those respective rows.

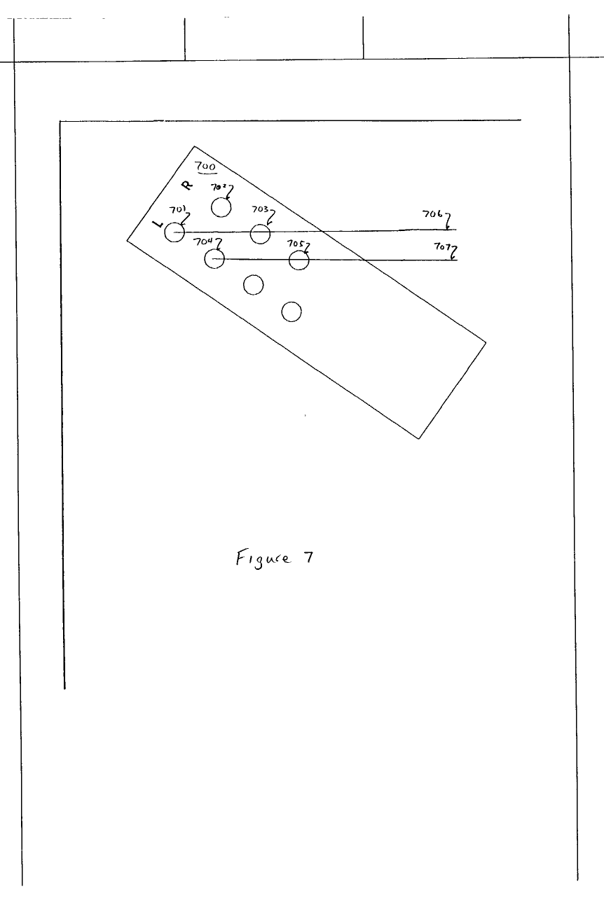

FIG. 7 shows one embodiment of the present invention where the nozzle array is tilted such that nozzle redundancy is provided between offset nozzles. Again, print head 700 includes two columns of nozzles. However, the nozzle array is tilted at a greater angle such that nozzle redundancy is achieved by an offset nozzle in the second column. The print head 700 is tilted such that the first nozzle 701 of the left column resides on the same line 706 as the second nozzle 703 of the right column. Similarly, the second nozzle 704 of the left column resides on the same line 707 as the third nozzle 705 of the right column. This embodiment may be advantageous as it provides for greater horizontal separation between the two redundant nozzles. This concept of increasing the angle of tilt can be extended such that virtually any of the nozzles belonging to the left column can be horizontally aligned with any of the nozzles belonging to the right column.

It should be noted that the present invention is applicable to scanning inkjet printers as well as stationary inkjet printers. In a scanning inkjet printer, one or more cartridges containing a tilted nozzle array is horizontally scanned across the print medium to deposit a line of ink. In a stationary inkjet printer an entire line of ink is deposited by implementing multiple cartridges, at least one of which contains a tilted nozzle array. It should also be noted that any of the cartridges can be black and/or color ink.

Therefore, the embodiments of the present invention, an inkjet printer having a print head with a nozzle array which is tilted relative to the print medium, has been described. While the present invention has been described in particular embodiments, it should be appreciated that the present invention should not be construed as limited by such embodiments, but rather construed according to the below claims.

What is claimed is:

1. A printer comprising:
a cartridge having an array of nozzles for disposing ink onto a print medium, wherein said array of nozzles includes at least two columns of nozzles which are tilted at an angle relative to the print medium for achieving nozzle redundancy.

2. The printer of claim 1, wherein the two columns of nozzles has a Y-axis which is different from a Y-axis corresponding to said print medium.

3. The printer of claim 1 further comprising an actuator which rotates said cartridge to tilt said array of nozzles relative to said print medium.

4. The printer of claim 1, wherein at least two nozzles of said array of nozzles are fired simultaneously to increase a spot size.

5. The printer of claim 1 further comprising a drop detector which provides feedback to a controller to switch from a malfunctioning nozzle to a functioning nozzle.

6. The printer of claim 1 further comprising a second set of nozzles which are not tilted relative to the print medium.

7. The printer of claim 1, wherein said angle is approximately two degrees.

8. The printer of claim 1 further comprising a third column of nozzles.

9. The printer of claim 1, wherein a first nozzle of a first column is aligned with a first nozzle of a second column for printing a same line on said print medium.

10. The printer of claim 1, wherein a first nozzle of a first column is aligned with a second nozzle of a second column for printing a same line on said print medium.

11. A method for printing, comprising:
ejecting ink through a nozzle array comprising at least two columns of nozzles which are vertically mis-aligned relative to a print medium upon which said ink is deposited in order to have at least two nozzles capable of depositing ink onto a same line.

12. The method of claim 11 further comprising:
tilting a print head having said nozzle array in order to offset an X and Y axis of said nozzle array from an X and Y axis of said print medium.

13. The method of claim 11 further comprising:
tilting the print head to achieve a redundant nozzle array configuration.

14. The method of claim 11 further comprising:
firing at least two nozzles of said array of nozzles simultaneously to increase a spot size.

15. The method of claim 11 further comprising:
detecting drops to identify a malfunctioning nozzle;
switching printing from said malfunctioning nozzle to a redundant nozzle which is properly functioning.

16. An inkjet printer, comprising:
a print head having a first nozzle and a second nozzle for disposing ink onto a print medium, wherein said first nozzle and said second nozzle are horizontally aligned relative to said print medium and wherein said first nozzle and said second nozzle are horizontally staggered relative to said print head.

17. The inkjet printer of claim 16, wherein said inkjet printer comprises a scanning inkjet printer.

18. The inkjet printer of claim 16, wherein said inkjet printer comprises a stationary inkjet printer.

19. A printer comprising:
a single print head having an array of staggered nozzles for disposing ink onto a print medium;
a controller coupled to said single print head, wherein said controller selectively controls said print head to print in either a staggered array configuration or a tilted redundant array configuration.

20. The printer of claim 19 further comprising:
an actuator coupled to said single print head, wherein said controller selectively commands said actuator to rotate and un-rotate said print head.

21. The printer of claim 19 further comprising a drop detector for switching printing from a malfunctioning nozzle to a corresponding functioning nozzle.

22. The printer of claim 19, wherein at least two redundant nozzles are fired simultaneously to produce an increased spot size.
